(19) United States
(12) Patent Application Publication
(10) Pub. No.: US 2005/0163937 A1
(43) Pub. Date: Jul. 28, 2005

(54) Method for photopolymerization of a polymerisable coating, installation therefor and product comprising the coating obtained

(76) Inventors: Bernard Hansz, Nommay (FR); Jean-Jacques Gauthier, Thann (FR); Francis Benhamou, Saint Didier au Mont D'or (FR)

Correspondence Address: FOLEY AND LARDNER;SUITE 500, 3000 K STREET NW, WASHINGTON, DC, 20007, US

(21) Appl. No.: 10/506,667

(22) PCT Filed: Mar. 6, 2003
(86) PCT No.: PCT/FR03/00733

(30) Foreign Application Priority Data
Mar. 6, 2002 (FR) 02/02921

(51) Int. Cl. C08F 2/46; C08J 7/18; C08F 2/48

(52) U.S. Cl. 427/487; 427/508

(57) ABSTRACT

The invention concerns a method for photopolymerizing a polymerisable coating applied on a substrate as well as an installation for implementing said method, enabling very high quality coatings to be obtained and polymerization time to be significantly reduced. Said method is essentially characterized in that it consists in performing at least two rapid simultaneous or successive exposures of the coating deposited on the substrate to infrared rays having different wavelengths derived from at least one generator of short infrared rays (22a) and from at least one generator of medium infrared rays (22b) arranged on the side of said substrate surface (23). The invention is useful for coating industrial and/or household objects made of wood, metal, synthetic or composite materials, or mixtures thereof or the like.

### TECHNICAL FIELD

This invention concerns a method for photopolymerizing a coating applied on at least one surface of a substrate, characterized in that the coating applied on the substrate is subject to at least a first exposure to infrared rays having short or medium wavelength.

The concerned coatings are for instance paints, varnish, plastic coatings in powder and/or liquid form.

It also concerns an installation for implementing the method, consisting of at least one frame, at least one first exposure area of the coating equipped with generators of short or medium infrared waves.

The invention also concerns a product composed of a substrate covered on at least one of its surfaces with at least one polymerized coating.

In the following text, short and medium infrared rays will respectively be called infrared rays having their maximum peak emission under 1.4 microns respectively between 1.4 and 3 microns.

### PRIOR METHODS

The known polymerization methods are in general based on treatment in a hot air oven. In this case, heating is slow and it needs very long polymerization times, since it generally brings about a dry film at the surface of the coating to be polymerized before the inner layer of the coating has dried. In other words, there is a tendency to overheat the surface of the coating in order to achieve drying of the inner layer, hence the risk of blisters and/or overcooking.

Other more and more frequently used photopolymerization methods are the ones in which polymerization of a coating is achieved by means of short and medium infrared rays that penetrate the coating layer in order to dry it in its full thickness. Yet, this method is very difficult to adjust, representing the risks of overcooking or the unacceptable appearance of an orange peel. That is the reason why, with present-day installations, a preheating is carried out with the help of a short and/or medium wave spectrum, whereas the final cooking is done by means of hot air.

According to another approach, ultraviolet generators are used in combination with coatings containing photo-initiators that capture the energy of the rays, transmit it to the oligomers that are also contained in the coating, in order to initiate the chain reaction of polymerizing the coating. In this way, these photo-initiators permit photopolymerization at low temperatures. Nevertheless, in order to achieve a good polymerization, thickness of the coating must be limited. Moreover, these specific coatings have a high cost price, thus making this method expensive to implement.

In order to overcome these difficulties, industry has been looking for other solutions.

For instance, the method described in publication WO-01/62401 relates to effectuating a powder coating of car body components, in which the paint, obtained from pigments in aqueous solution, is polymerized by heat only or by heat and actinic radiation.

The method described in publication WO-01/64794 relates to achieving polymerization of the paint by means of near infrared radiation and ultra violet radiation and/or electron radiation, applied successively or simultaneously, in preheating the paint by means of near infrared radiation and then polymerizing it by means of ultra violet radiation. So this method requires the use of specific paints and resins, which are sensitive to ultra violet radiation and have a high cost price.

The polymerization method described in publication WO-02/11903 is achieved in using infrared radiation and in particular near infrared radiation having a same wavelength. Use of near infrared radiation implies very high radiative power, and is particularly difficult to adjust, especially in thermosensitive substrates.

Finally, another method described in publication WO-00/35597 consists in exposing the surface to be treated to an ultraviolet radiation source which is provided with an infrared radiation fraction in its emission specter, and in alternately interposing between the radiation source and the surface to be treated ultraviolet filters and infrared filters in order to selectively provoke an ultraviolet or an infrared radiation, which limits the energetic return.

All of these known methods apply the energy required for photopolymerization in the form of various radiations in a more or less empirical way. An optimal polymerization, though, consists in an exact and precise control of temperature evolution in the very inner side of the paint layer.

As a consequence, above described methods will only result in a medium quality of the paint layer or quality may even be unpredictable, moreover exposure times to radiation are long, which has a negative influence on the productivity of such installation. These methods do not allow treating substrates with complex shapes, nor successive series of substrates with different shapes. So, they have but a limited application.

### DISCLOSURE OF THE INVENTION

Objective of the present invention is to overcome the above-mentioned inconveniences in offering a method of photopolymerizing a paint layer applied on a substrate as well as an installation for implementing this method in a simple and economic way, allowing to considerably reduce polymerization time, to treat substrates having complex shapes, to successively treat a series of substrates with different shapes and to considerably improve the quality of the obtained painted substrates.

This objective is achieved through the method specified in the introduction and characterized in that the coating is submitted to at least a second exposure to infrared rays having a medium respectively short wavelength, the short and medium infrared rays derived from generators of short and medium infrared rays, arranged on the side of said substrate surface.

The first exposure would preferably be effected to infrared rays having a short wavelength, and the second exposure to infrared rays having a medium wavelength.

Preferably, each exposure should be modulated in power and/or in time in accordance with the instantaneous temperature of the coating.

Depending upon the needs, said exposures can be performed simultaneously or successively, so that duration of each exposure will be less than thirty seconds and preferably less than five seconds. At least one additional exposure by means of medium infrared rays can be performed, too.

Advantageously, the substrate is moved, according to a predetermined path, compared to the generators of short and/or medium infrared rays, and/or the generators of short and medium infrared rays compared to the substrate.

Beneficially, a set of exposure sequences is carried out, each sequence comprising at least the first and the second exposure.

The simultaneous and/or successive use of short and medium infrared rays allows a rise in temperature of the interface situated between the substrate and the coating according to a curve shifted vis-à-vis the one of the substrate surface.

Preferably, use is made of generators of rapid infrared rays featuring a weak thermal inertia and an emission or extinction start time of less than one second, the short infrared rays having a wavelength of the emission peak situated between 0.4 and 1.4 micrometers, and preferably approximately equaling 1 micrometer, and the medium infrared rays having a wavelength of the emission peak situated between 1.4 and 3 micrometers, and preferably approximately equaling 1.7 micrometers.

According to variants, ultraviolet rays combined with the said short and medium infrared rays can be used.

This objective is also achieved through the installation as defined in the introduction and characterized in that it comprises at least one second exposure area fitted with generators of medium respectively short infrared rays, the generators of short and medium infrared rays being arranged on the side of the substrate surface.

Advantageously, the first exposure area is equipped with generators of short infrared rays and the second exposure area with generators of medium infrared rays.

Preferably the installation comprises at least one additional generator of medium infrared rays.

In a preferred embodiment, the generators of short or medium infrared rays are adjustable in power and/or in time according to the instantaneous temperature of said coating and fitted in such a way that the exposure areas are at least partially superposed.

Preferably, the installation comprises conveying means fitted for moving—according to a predetermined path—the substrate vis-à-vis the generators of short and/or medium infrared rays, and/or the generators of short and/or medium infrared rays vis-à-vis the substrate.

Advantageously, the generators of short and/or medium infrared rays are arranged in group, each comprising at least one generator of short infrared rays and at least one generator of medium infrared rays.

In a preferred embodiment of the invention, the generators of short and/or medium infrared rays are movably mounted in translation vis-à-vis the frame and connected to drive means configured to modify the exposure distance between the generators of short and/or medium infrared rays and the substrate surface.

In order to polymerize at least one coating applied on two opposite surfaces of one same substrate, the generators of short and/or medium infrared rays are arranged on each side of the substrate, so that the two opposite surfaces will be subject to exposure.

Preferably, the generators of short and/or medium infrared rays are mounted on at least one gantry suspended to the frame and borne by at least one mobile carriage in a translating manner in at least one guiding rail integral with the frame, the drive means comprising at least one actuator and one transmission between actuator and carriage.

The exposure means can also be mounted movably in rotation vis-à-vis the frame around shafts and connected to pivoting facilities configured to modify the exposure angle on the said substrate surface to be treated, in making the generators of short and/or medium infrared rays rotate simultaneously or independently.

In the preferred embodiment, each generator of short and/or medium infrared rays is lodged in a cassette coupled to the pivoting facilities, and the cassettes are mounted adjacently onto the gantry.

Advantageously, each cassette comprises an approximately cylindrical tubular body fitted with at least one reflector, in front of which at least one emitting tube is placed, constituting a generator of short and/or medium infrared rays.

Moreover, the cassette may be hollow so that it can be traversed by a cooling air circuit.

According to alternative embodiments of the invention, exposure means may comprise generators of ultraviolet rays used in combination with the said generators of short and medium infrared rays.

According to the preferred embodiment, the installation comprises at least one auxiliary generator of short and/or medium infrared rays arranged on one lateral end of at least one exposure area defined by the preceding generators of short and medium infrared rays; this auxiliary generator can also be coupled to pivoting facilities.

Advantageously, this installation is supplemented with at least one computerized management unit in view of automatically controlling the generators of short and medium infrared rays, the drive means and pivoting facilities according to the shape and dimensions of the substrate as well as the thickness and the nature of the paint layer to be polymerized.

This objective is also achieved through the product in accordance with the introduction and characterized in that it is obtained by the preceding method.

### BRIEF DESCRIPTION OF THE DRAWINGS

The present invention and its advantages will be better understood with reference to the detailed description of a preferred implementation of the method of the invention, in conjunction with the accompanying drawings, included solely for illustrative purposes and not in any way intended to limit the invention, in which

FIG. 1 is a schematic representation of an installation for implementing the method in accordance with the prior art.

FIG. 2 is a schematic representation of an installation for implementing the method in accordance with the invention.

FIG. 3 is an overview of an installation in accordance with the invention.

FIG. 4 is a schematic representation of one side of the exposure means of the installation shown in FIG. 3 in accordance with the arrows IV-IV.

FIG. 5 is a schematic representation of a cross-section in accordance with the arrows V-V of the installation shown in FIG. 3.

FIG. 6 is an enlarged cross-section of a cassette equipped with a generator of infrared rays forming the said exposure means of FIG. 4, and

FIG. 7A-B are partial views respectively from above, from the side and from the face of the exposure means of FIG. 4.

### ILLUSTRATION OF THE PRIOR TECHNIQUE

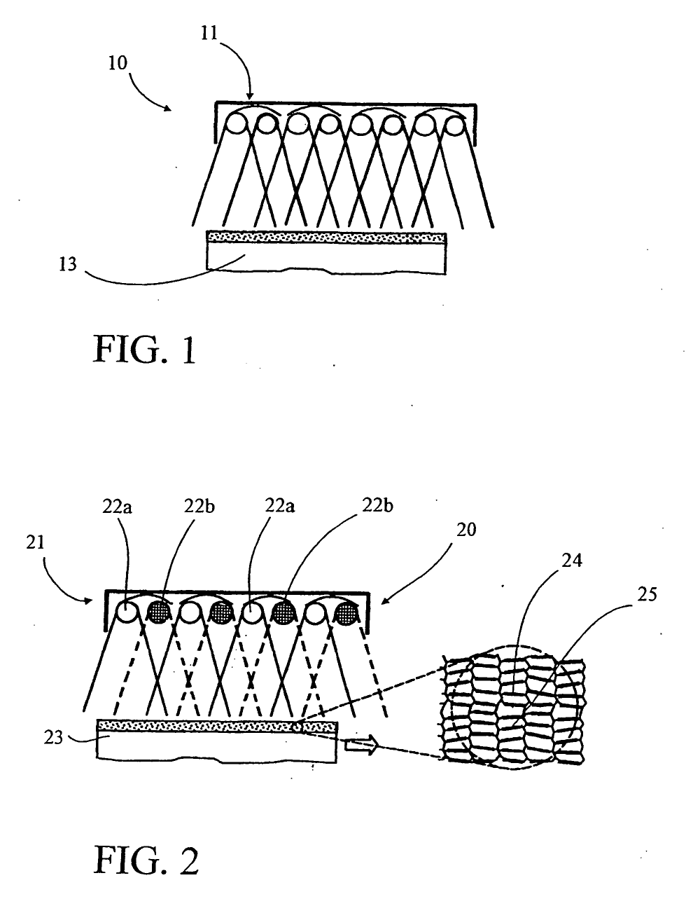

FIG. 1 is a schematic illustration of an installation 10 in accordance with the prior art, comprising one single cassette 11 of generators of infrared rays having a predetermined wavelength, either short or medium. These infrared rays are applied during a long time on the substrate surface to be treated 13, previously covered with a powder coating or coating in solution, such as for instance polyester type paints, varnish, a coating made out of synthetic materials or any other similar coating containing polymerisable oligomeres. This method takes a long time to implement. Moreover, due to adjusting difficulties, the final result is a bad quality coating, insufficiently polymerized or overheated, with formation of blisters and reduced hardness and lifetime.

### ILLUSTRATION OF THE INVENTION

Installation 20 in accordance with the invention and illustrated in FIG. 2 comprises one single cassette 21 fitted with generators of infrared rays with different wavelengths, for instance generators of short infrared rays 22a and generators of medium infrared rays 22b. These generators of short 22a and medium 22b infrared rays are preferably of the rapid type and featuring emission and extinction start times of less than one second. The short infrared rays can have a wavelength of the emission peak situated at least between 0.4 and 1.4 micrometers and preferably approximately equaling 1 micrometer, and the medium infrared rays may have a wavelength of the emission peak situated between 1.4 and 3 micrometers and preferably approximately equaling 1.7 micrometers. In the illustrated example, the generators of short 22a and medium 22b infrared rays are arranged within the cassette 21, in an alternative way, which allows to achieve a rapid sequential exposure of the substrate surface 23, which continuously passes in front of the generators of short 22a and medium 22b infrared rays.

Alternative, not represented arrangements of the generators of short 22a and medium 22b infrared rays within the cassette 21 may also be envisaged.

The short and medium infrared rays are applied on the substrate surface 23 to be treated, this surface having previously been covered with a layer of paint, e.g. in powder, in solution or in suspension, of a polyester type or the like, containing oligomeres polymerisable respectively under the effect of short or medium infrared rays. Thanks to the particular arrangement of the generators of short 22a and medium 22b infrared rays, short infrared rays and medium infrared rays are applied simultaneously or successively in rapid sequences, provoking a simultaneous polymerization of the oligomeres 24 responding to short infrared rays and the oligomeres 25 responding to medium infrared rays, these latter can no longer be entrapped by the first ones. In this way, the interface between the coating and the substrate 23 is heated by priority and temperature is progressively raised from within the thickness of the coating up to its surface. In this way, it is achieved that the interface and the coating, both featuring different thicknesses, follow different temperature curves. The final result is a very high quality coating, a considerably improved coating hardness and a reduced treatment time. Treating times vary between 8-10 minutes in the prior art, and between 1-3 minutes with the method of invention, the duration of each exposure being less than thirty seconds and preferably less than five seconds. The achieved BUCHHOLZ hardness of the coating rises from 80-90 up to 110 with the method of the invention.

The substrate 23 is usually in movement and passes underneath the cassette 21 of the generators of short 22a and medium 22b infrared rays. These generators of rays have been described in reference with FIG. 2 as being generators of short 22a and medium 22b infrared rays. They may also include generators of ultraviolet rays and/or generators of long infrared rays. All the combinations are possible depending upon the nature of the coatings and the nature of the substrates 23 and the surface to be treated. This surface may be out of metal, wood, synthetic material, composite material, or mixtures thereof or the like. Before applying the paint layer, the substrate 23 may of course undergo physical and/or chemical pretreatments known as for instance stripping, degreasing, shot blasting, sand blasting, preheating, etc., that will facilitate and improve application of the paint layer and next its polymerization by means of infrared rays.

### BEST WAY OF IMPLEMENTING THE INVENTION

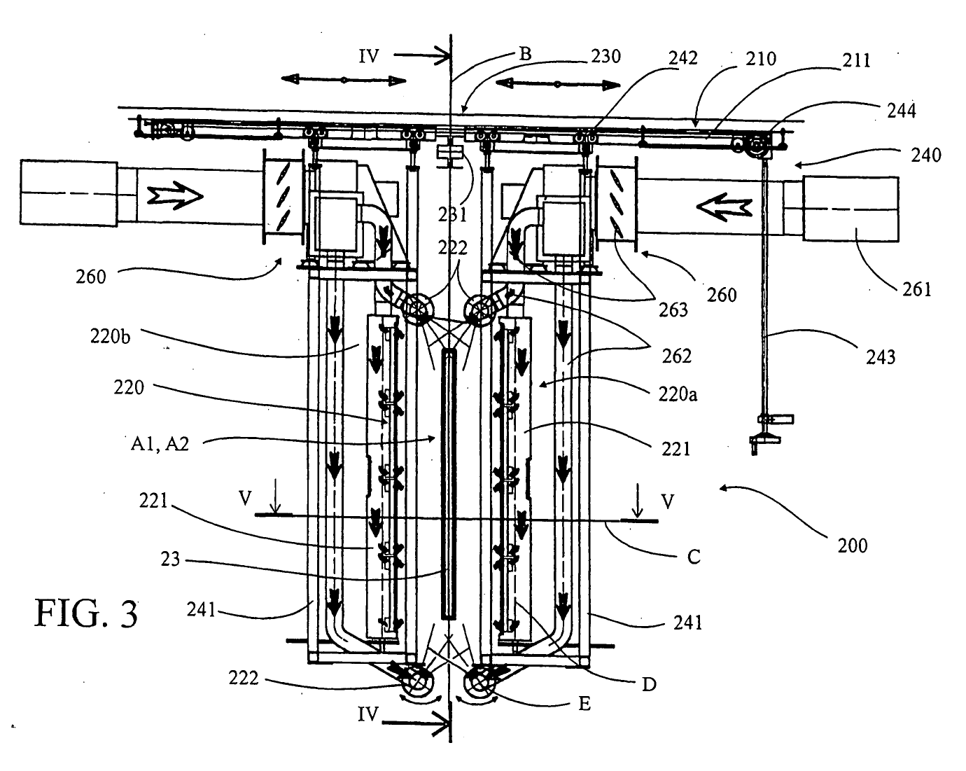

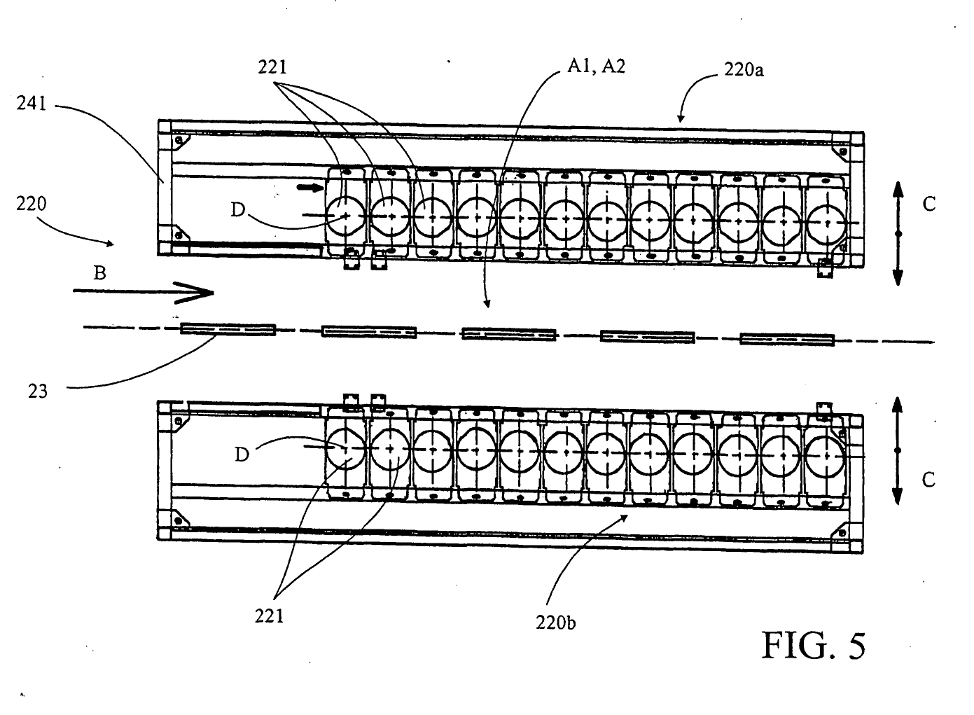

FIGS. 3 to 7 illustrate a way of preferred implementation of an installation 200 according to the invention. This installation 200 is an infrared ray oven comprising a frame 210, exposure areas A1, A2 well delimited by the generators of short 22a and medium 22b infrared rays, the exposure areas have to be at least partially superposed. The installation 200 also comprises conveying means 230 of a substrate 23 configured for conveyance according to a predetermined path along de said exposure area A. This installation 200 is characterized in that it is suspended. Indeed, the frame 210 consists in guiding rails 211 attached for instance to the ceiling so that it can hold the generators of short 22a and medium 22b infrared rays, that have the shape of two panels 220a, 220b suspended vertically on either side of the median plane B of the installation 200 (cf. FIG. 3) and corresponding to the path of the substrate 23. The substrate 23 itself is also suspended vertically to a transport rail 231, attached for instance to the ceiling in plane B. As we will see later on, the generators of short 22a and medium 22b infrared rays are movably mounted in translation according to a shaft C perpendicular to plane B (cf. FIG. 3) so as to adjust the exposure distance to the shape of the substrate 23 to be treated.

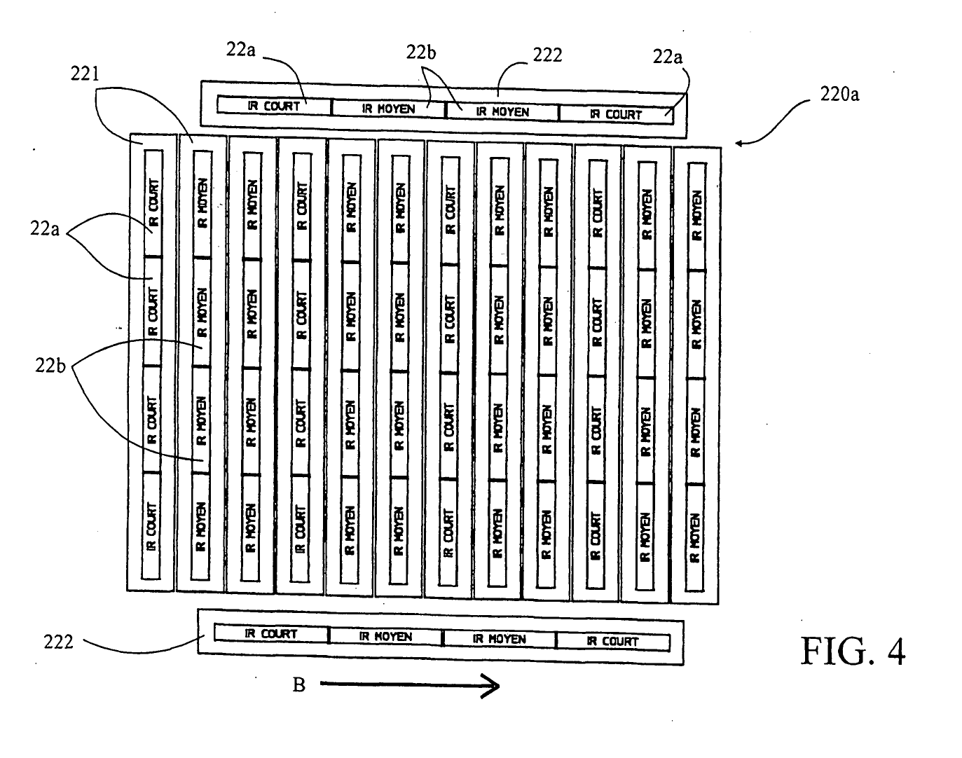

Each panel 220a 220b consists, with reference to FIG. 4, of a series of cassettes 221 arranged adjacently and extending approximately vertically, i.e. approximately perpendicular to the direction of the substrate's 23 travel, so as to irradiate the sides of the substrate 23 over the full height. In the represented example, these panels 220a, 220b are supplemented with auxiliary cassettes 222 arranged at the top and the bottom on either side of the series of cassettes 221, and extending in longitudinal direction, i.e. approximately parallel to the direction of the substrate's 23 travel, so as to irradiate the upper and lower fields of the substrate 23.

In the represented example, each cassette 221 comprises a series of generators of infrared rays of the same wavelength, either short 22a or medium 22b, for instance four lined up generators. The cassettes 221 with different wavelengths alternate in the direction of the substrate's 23 travel.

In other not represented alternative embodiments, each cassette can hold generators of infrared rays of different wavelengths.

In FIG. 4, starting from the left, the first cassette 221 comprises generators of short 22a infrared rays (IR courts) and the following two cassettes 221 generators of medium 22b infrared rays (IR moyens). This group of 3 cassettes 221 is repeated three times in the same order, each panel 220a, 220b comprising a total of twelve cassettes 221. In this way, each group of three cassettes 221 defines an exposure sequence: one exposure to short infrared rays followed by two exposures to medium infrared rays, this exposure sequence repeats itself successively and rapidly on the substrate 23 moving past. Other arrangements can also be envisaged in order to define other repetitive exposure sequences.

In FIG. 4 and starting from the left, the auxiliary cassettes 222 comprise from left to right: one generator of short 22a infrared rays (IR courts), two generators of medium 22b infrared rays (IR moyens) and one generator of short 22a infrared rays (IR courts). Other arrangements can be envisaged, too.

These panels 220a, 220b are movably mounted in translation according to an axis C approximately perpendicular to plane B (cf. FIG. 3) and connected with drive means 240 allowing to adapt exposure distance between the generators of short 22a and medium 22b infrared rays and the substrate 23 to the shape of the substrate 23 to be treated. The axis C may have any other adapted orientation. The cassettes 221, 222 forming each panel 220a, 220 b are mounted on a gantry 241 suspended to the said frame 210. This gantry 241 is supported by movable carriages 242 in translation within the guiding rails 211. In the example represented, the drive means 240 comprise an actuator in the form of a handle 243 controlling the displacement of the carriages 242 by means of a chain transmission and chain wheels 244. This is of course but an example amongst all the known mechanisms such as the systems rack/pinion, pulley/belt, etc. which may be controlled manually or automatically by engines or screws. The drive means 240 of the two panels 220a, 220b may be linked so that they will move simultaneously and inversely. They may also be independent of each other. In automatic mode, the width of exposure area A may be adapted to the shape of the substrate 23, detected before it enters the oven, for instance by means of a scanner. In this way, for a relatively narrow substrate 23, the panels 220a, 220b are drawn nearer, whereas for a more voluminous substrate 23 the two panels 220a, 220b are moved further apart according to the largest width of the substrate 23. The exposure distance generally lies between 2 cm and 150 cm, this exposure distance is linked with the flux emitted by the generators of short 22a and medium 22b infrared rays and with the relative displacement velocity of the substrate 23 vis-à-vis the generators of short 22a and medium 22b infrared rays.

According to a not represented alternative embodiment, each generator of short 22a and medium 22b infrared rays may be integral with a mobile carriage independently vis-à-vis other carriages supporting the other generators of short 22a or medium 22b infrared rays. In a like manner, the installation may comprise several mutually independent fixed or mobile gantries.

The exposure distance may be constant or variable and adapted during exposure.

According to a not represented alterative embodiment, the substrate is immobile and the exposure panels are mobile according to a predetermined path.

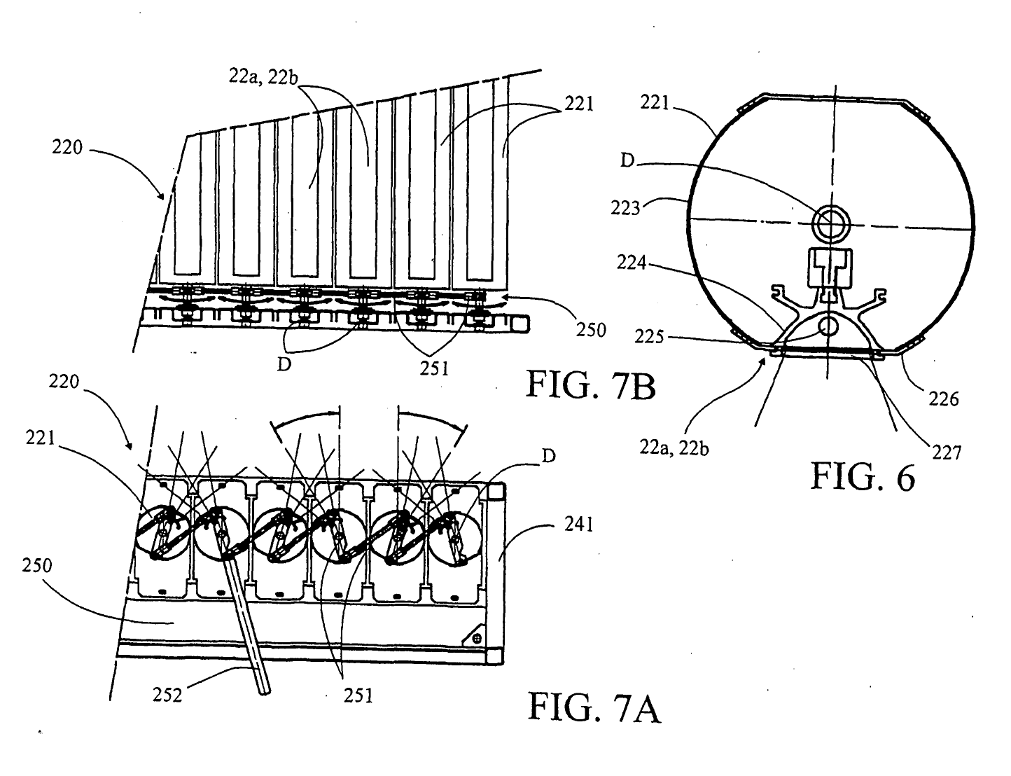

With reference to FIG. 6, each cassette 221, 222 comprises in the represented figure, an approximately cylindrical tubular body 223 fitted with a longitudinal opening closed by a parabolic reflector 224, in front of which an emitting tube 225 of infrared rays is placed. The reflector 224 is mounted in a body 223 by means of a profile 226 which is lodged in a peripheral groove of the reflector 224 and attached onto the body 223 by means of screws, rivets, welds or an other equivalent way. The reflector 224 and the emitting tube 225 constitute the said generators of infrared rays 22a, 22b. This reflector 224 may be supplemented with fins 227 placed at the front of the emitting tube 225 and assuming the role of creating air cushions in front of this emitting tube 225 in order to protect it from the solvents released by the layer of paint during polymerization.

The body 223 of each cassette 221, 222 being hollow allows to have air circulated therein in order to evacuate calories released by the emitting tubes 225 and to avoid the risks of overheating and cracking of the tubes. To this effect, installation 200 comprises air circuits 260 fitted with fans 261 that blow fresh air into the cassettes 221, 222 via pipes 262 and regulating valves 263.

Installation 200 comprises moreover air extractors (not represented) in the upper portion in order to evacuate hot ambient air mixed with the solvents released by the paint during polymerization and to avoid the risks of explosion. This air extraction is done symmetrically at the inner side of the oven in order to preserve its equilibrium.

Exposure means 220 are also mobile in rotation. To this effect, each cassette 221, 222 is movably mounted in rotation on the gantry 241 and is connected to orientation means 250 configured to adapt the exposure angle to the substrate 23 to be treated. The cassettes 221 are mobile around an axis D approximately perpendicular to the direction of the substrate's 23 travel and the cassettes 222 are mobile around an axis E approximately parallel to the direction of the substrate's 23 travel. The rotation of these cassettes 222 may be implemented manually by means of a simple handle or automatically by means of an engine or a screw.

FIGS. 7A and B illustrate a way of embodiment of the orientation means 250, in which the cassettes 221 of one and the same panel 220a or 220b are interconnected by means of a system of link rods 251 controlled by an actuator in the form of a handle 252. Of course, this is but an example amongst all known mechanisms such as the systems of rack/pinion, pulley/belt, gears etc. that may be controlled manually or automatically by engines or screws. It is also possible to envisage an individual control of the rotation of each cassette 221 for instance by means of engines step by step that can be easily programmed.

The cassettes 221 being cylindrical may be advantageously arranged one against the other while remaining mobile one vis-à-vis the other. Being adjacent they prevent the infrared rays to pass between them, in consequence of which the outer walls of the oven would heat up, leading to important energy losses and significant losses of output.

This installation 200 is supplemented with a programmable computerized management unit configured to manage and control the working parameters of the oven (travel of the substrate 23, cooling off and air extraction circuits, etc..) and to automatically control the exposure means 220 as well as the drive means 240 and the pivoting means 250 according to the shape and dimensions of the substrate 23 as well as to the thickness and the nature of the layer of paint to be polymerized. This installation 200 allows polymerizing the layer of paint on the substrate 23 whether it is independently applied on one of the faces or on both opposite faces by selecting one of the panels or both panels 220a, 220b of the exposure means 220.

The particular construction of the installation 220 such as described allows to obtain a very compact oven, which doesn't need insulation, with various geometries according to the shape of the substrate 23 to be treated and, consequently, very flexible allowing to rapidly change series. The exposure means 220 such as described may be controlled individually in power and/or time, which allows obtaining a large flexibility and an optimal treatment quality. Moreover, its suspended concept makes cleaning of the floors easier, i.e. when it is installed in clean rooms with tiled floor.

This installation 200 allows implementation of the photopolymerization method in accordance with the invention of a layer of paint on at least one substrate 23 surface passing through. This method consists in subjecting the layer of paint to at least two exposures of infrared rays having different wavelengths derived from two independent generators of infrared rays arranged successively vis-à-vis the direction of the substrate's 23 travel, the first one being a generator of short 22a infrared rays and the second one a generator of medium 22b infrared rays and both generators are arranged on the side of the surface to be treated. The generator of short 22a infrared rays is configured to pass through the layer of paint and by priority to heat the interface between the substrate surface and the layer of the paint to a temperature situated between 100 and 300° C. and preferably approximately close to 190° C. according to the type of coating used. Whereas the generator of medium 22b infrared rays is in spectral accordance with the paint to be polymerized, so as to penetrate the inner side of the layer of paint and progressively raising its temperature starting from the interface up to the exterior face in order to achieve an exterior temperature between 50 and 90° C. and preferably near to 60° C.

These exposures may be carried out simultaneously or successively within a very short period of time. When the layer of paint to be polymerized is being applied on two opposite surfaces of the substrate, the generators of infrared rays 22a, 22b are arranged on each side of the substrate 23.

Obviously the method of photopolymerization may be implemented by other installations than the one described. For instance, it is not compulsory that the exposure means 220 are suspended. Likewise, it is not compulsory that the substrate 23 is suspended. In these different alternatives, the drive means 240 and the conveying means 23 have to guide respectively the exposure panels 220a, 220b and the substrate 23 in the upper and the lower parts.

The surface to be treated may be out of metal, wood, synthetic or composite materials or a mixture of these materials or the like.

The same principal of method and utilization applies to all types of equivalent generators. In this way, it is possible to use gas generators, provided that specific adaptations are made to this technology.

The present invention is not limited to the described examples but is broadened to all modifications and alternatives evident for an expert while remaining within the field of the annexed claims.

1. Method of photopolymerization of a coating on at least one substrate (23) surface, in which the said coating applied on the said substrate (23) is submitted to at least a first exposure of infrared rays having a short or medium wavelength, characterized in that the said coating is submitted to at least a second exposure of infrared rays having respectively medium or short wavelength, the said short or medium infrared rays derived from generators of short (22a) and medium (22b) infrared rays, arranged on the side of the said substrate surface (23).

2. Method according to claim 1, characterized in that the said first exposure is carried out to infrared rays having a short wavelength and the second exposure to infrared rays having a medium wavelength.

3. Method according to claim 1, characterized in that at least one additional exposure is carried out by mean of generators of medium (22b) infrared rays.

4. Method according to claim 1, characterized in that each exposure is modulated in power and/or time according to the instantaneous temperature of the said coating.

5. Method according to claim 1, characterized in that the said exposures are performed simultaneously.

6. Method according to claim 1, characterized in that the said exposures are performed successively so that duration of each exposure is less than thirty seconds and preferably less than five seconds.

7. Method according to claim 1, characterized in that the said substrate (23) is displaced according to a predetermined path vis-à-vis the said generators of short (22a) and/or medium (22b) infrared rays and/or the said generators of short (22a) and/or medium (22b) infrared rays vis-à-vis the said substrate.

8. Method according to claim 1, characterized in that it is proceeded to a series of sequences of exposures, each sequence comprising at least the said first and second exposures.

9. Method according to claim 1, characterized in that a raise in temperature of the interface situated between de said substrate (23) and the said coating is performed according to a curve shifted vis-à-vis the one of the substrate surface (23).

10. Method according to claim 1, characterized in that use is made of at least short infrared rays of which the wavelength of the emission peak is situated between 0.4 and 1.4 micrometers and preferably approximately equaling 1 micro meter and at least medium infrared rays with a wavelength of the emission peak situated between 1.4 and 3 micrometers, preferably approximately equaling 1.7 micrometers.

11. Method according to claim 1, characterized in that generators of rapid infrared rays (22a, 22b) are used, featuring a weak thermal inertia and emission and extinction start times of less than one second.

12. Method according to claim 1, characterized in that also ultraviolet rays are used in combination with the said short and medium infrared rays.

13. Installation (20, 200) for implementing the method of photopolymerizing a coating applied on at least one surface of a substrate (23), this installation comprising at least one frame (210), at least a first exposure area (A1) of the said coating, fitted with generators of short (22a) or medium (22b) infrared rays, characterized in that it comprises at least a second exposure area (A2) fitted with generators of respectively medium (22b) or short (22a) infrared rays, said generators of short (22a) and medium (22b) infrared rays arranged on the side of the said surface substrate (23).

14. Installation according to claim 13, characterized in that the said first exposure area (A1) is fitted with generators of short (22a) infrared rays and the second exposure area (A2) is fitted with generators of medium (22b) infrared rays.

15. Installation according to claim 13, characterized in that it comprises at least one additional generator of medium (22b) infrared rays.

16. Installation according to claim 13, characterized in that the said generators of short (22a) and/or medium (22b) infrared rays are adjustable in power and/or time according to the instantaneous temperature of the said coating.

17. Installation according to claim 13, characterized in that the said generators of short (22a) and/or medium (22b) infrared rays are arranged in such a way that the said exposure area (A1, A2) are at least partially superposed.

18. Installation according to claim 13, characterized in that it comprises conveying means (230a) configured to move in accordance with a predetermined path, the said substrate (23) vis-à-vis the said generators of short (22a) and/or medium (23) infrared rays and/or the said generator of short (22a) infrared rays vis-à-vis the said substrate (23).

19. Installation according to claim 13, characterized in that the said generators of short (22a) and/or medium (22b) infrared rays are arranged in group, each comprising at least one generator of short (22a) infrared rays and at least one generator of medium (22b) infrared rays.

20. Installation according to claim 13, characterized in that the said generators of short (22a) and/or medium (22b) infrared rays are mounted movably in translation vis-à-vis the said frame (210) and connected to drive means (240) configured to modify the exposure distance between the said generators of short (22a) and/or medium (22b) infrared rays and the said substrate (23) surface.

21. Installation according to claim 13 configured to polymerize at least one coating applied on two opposite surfaces of the same substrate (23), characterized in that the said generators of short (22a) and/or medium (22b) infrared rays are arranged on each side of the said substrate (23) to expose it on the two opposite surfaces.

22. Installation according to claim 20, characterized in that the said generators of short (22a) and/or medium (22b) infrared rays are mounted on at least one gantry (241) suspended to the said frame (210) and supported by at least one carriage (242) movable in translation in at least one guiding rail (211) fixed to the said frame (210) and in that the said drive means (240) comprise at least one actuator (243) and one transmission (244) between the said actuator (243) and the said carriage (242).

23. Installation according to claim 13, characterized in that the said generators of short (22a) and/or medium (22b) infrared rays are mounted movably in rotation vis-a-vis the said frame (210) around axes (D) and are connected to pivoting means (250) configured to modify the exposure angle on the said substrate (23) surface in making the said generators of short (22a) and/or medium (22b) infrared rays rotate simultaneously or independently.

24. Installation according to claim 23, characterized in that each generator of short (22a) and/or medium (22b) infrared rays is lodged in a cassette (221) coupled to the said pivoting means (250), the said cassettes (221) mounted adjacently on the said gantry (241).

25. Installation according to claim 24, characterized in that each cassette (221) comprises an approximately cylindrical tubular body (223) fitted with at least one reflector (224) in front of which at least one emitting tube (225) is placed, forming the said generators of short (22a) and/or medium (22b) infrared rays.

26. Installation according to claim 25, characterized in that the said cassettes (221) are hollow and passed through by a cooling air circuit (260).

27. Installation according to claim 13, characterized in that it comprises generators of ultraviolet rays used in combination with the said generators of short (22a) and medium (22b) infrared rays.

28. Installation according to claim 13, characterized in that it comprises at least one auxiliary generator (222) of short and/or medium infrared rays arranged at one lateral end of at least one of the said exposure areas (A1, A2) defined by the said generators of short (22a) and medium (22b) infrared rays, the auxiliary generator (222) being coupled to the pivoting means.

29. Installation according to claim 13, characterized in that it comprises at least one computerized management unit configured to automatically control the said generators of short (22a) and medium (22b) infrared rays, the said drive means (240) and the pivoting means (250) according to the shape and the dimensions of the said substrate (23) as well as to the thickness and the nature of the layer of the coating to be polymerized.

30. Product constituted of a substrate (23) covered on at least one of its surfaces with an at least polymerized coating, characterized in that it is obtained by the method according to claim 1.
